(19) United States
(12) Patent Application Publication
(10) Pub. No.: US 2020/0401982 A1
(43) Pub. Date: Dec. 24, 2020

(54) TECHNIQUES FOR MULTISTEP DATA CAPTURE FOR BEHAVIORAL PAIRING IN A TASK ASSIGNMENT SYSTEM

(71) Applicant: Afiniti, Ltd., Hamilton (BM)

(72) Inventor: Muhammad ARBAB, Hyderabad (PK)

(73) Assignee: Afiniti, Ltd., Hamilton (BM)

(21) Appl. No.: 16/444,133

(22) Filed: Jun. 18, 2019

(51) Int. Cl. G06Q 10/06; H04M 3/51; H04M 3/523

(52) U.S. Cl. CPC G06Q 10/063112; H04M 3/5232; H04M 3/5166; H04M 3/5183

(57) ABSTRACT

Techniques for behavioral pairing in a task assignment system are disclosed. In one particular embodiment, the techniques may be realized as a method for behavioral pairing in a task assignment system comprising: receiving, by at least one computer processor communicatively coupled to and configured to operate in the task assignment system, information about a plurality of tasks; transmitting, by the at least one computer processor, the received information to a plurality of queues, each queue including a plurality of agents; and pairing, by the at least one computer processor, a task allocated to a first queue of the plurality of queues to an agent allocated to the first queue based at least in part on the received information.

### FIELD OF THE DISCLOSURE

The present disclosure generally relates to behavioral pairing and, more particularly, to techniques for multistep data capture for behavioral pairing in a task assignment system.

### BACKGROUND OF THE DISCLOSURE

A typical task assignment system algorithmically assigns tasks arriving at a task assignment center to agents available to handle those tasks. At times, the task assignment center may be in an “L1 state” and have agents available and waiting for assignment to tasks. At other times, the task assignment center may be in an “L2 state” and have tasks waiting in one or more queues for an agent to become available for assignment. At yet other times, the task assignment system may be in an “L3 state” and have multiple agents available and multiple tasks waiting for assignment.

In some typical task assignment centers, tasks are assigned to agents ordered based on time of arrival, and agents receive tasks ordered based on the time when those agents became available. This strategy may be referred to as a “first-in, first-out,” “FIFO,” or “round-robin” strategy. For example, in an L2 environment, when an agent becomes available, the task at the head of the queue would be selected for assignment to the agent.

In other typical task assignment centers, a performance-based routing (PBR) strategy for prioritizing higher-performing agents for task assignment may be implemented. Under PBR, for example, the highest-performing agent among available agents receives the next available task. Other PBR and PBR-like strategies may make assignments using specific information about the agents.

“Behavioral Pairing” or “BP” strategies, for assigning tasks to agents, improve upon traditional assignment methods. BP targets balanced utilization of agents while simultaneously improving overall task assignment center performance potentially beyond what FIFO or PBR methods will achieve in practice.

In some task assignment systems, tasks may be allocated to a plurality of queues of agents without typically transmitting all of the information about the allocated tasks to each of the respective queues. However, if a queue operates under BP strategy, it may be advantageous for each of the queue to have more information about the tasks arriving at the task assignment system. Thus, it may be understood that there may be a need for transmitting more information about tasks arriving at a task assignment system to all queues of agents in order to optimize the overall performance task assignment system.

### SUMMARY OF THE DISCLOSURE

Techniques for behavioral pairing in a task assignment system are disclosed. In one particular embodiment, the techniques may be realized as a method for behavioral pairing in a task assignment system comprising: receiving, by at least one computer processor communicatively coupled to and configured to operate in the task assignment system, information about a plurality of tasks; transmitting, by the at least one computer processor, the received information to a plurality of queues, each queue including a plurality of agents; and pairing, by the at least one computer processor, a task allocated to a first queue of the plurality of queues to an agent allocated to the first queue based at least in part on the received information.

In accordance with other aspects of this particular embodiment, the task assignment system may be a contact center system.

In accordance with other aspects of this particular embodiment, the received information may comprise at least one of a telephone number or a customer identifier associated with each of the plurality of tasks.

In accordance with other aspects of this particular embodiment, the received information may comprise at least one of an interactive voice response or a menu selection associated with each of the plurality of tasks.

In accordance with other aspects of this particular embodiment, the method may further comprise, prior to the transmitting, storing, by the at least one computer processor and on a storage device, the received information.

In accordance with other aspects of this particular embodiment, the method may further comprise: receiving historical pairing information from each of the plurality of queues; and transmitting the historical pairing information received from each of the plurality of queues to each other of the plurality of queues.

In accordance with other aspects of this particular embodiment, the pairing may be further based at least in part on the received historical pairing information.

In another particular embodiment, the techniques may be realized as a system for behavioral pairing in a task assignment system comprising at least one computer processor communicatively coupled to and configured to operate in the task assignment system, wherein the at least one computer processor is further configured to perform the steps in the above-described method.

In another particular embodiment, the techniques may be realized as an article of manufacture for behavioral pairing in a task assignment system comprising a non-transitory processor readable medium and instructions stored on the medium, wherein the instructions are configured to be readable from the medium by at least one computer processor communicatively coupled to and configured to operate in the task assignment system and thereby cause the at least one computer processor to operate so as to perform the steps in the above-described method.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

To facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows a block diagram of a task assignment system according to embodiments of the present disclosure.

FIG. 2 shows a block diagram of a task assignment center according to embodiments of the present disclosure.

FIG. 3 shows a block diagram of a task assignment center according to embodiments of the present disclosure.

FIG. 4 shows a flow diagram of a task assignment method according to embodiments of the present disclosure.

### DETAILED DESCRIPTION

A typical task assignment system algorithmically assigns tasks arriving at a task assignment center to agents available to handle those tasks. At times, the task assignment center may be in an “L1 state” and have agents available and waiting for assignment to tasks. At other times, the task assignment center may be in an “L2 state” and have tasks waiting in one or more queues for an agent to become available for assignment. At yet other times, the task assignment system may be in an “L3 state” and have multiple agents available and multiple tasks waiting for assignment. An example of a task assignment system is a contact center system that receives contacts (e.g., telephone calls, internet chat sessions, emails, etc.) to be assigned to agents.

In some traditional task assignment centers, tasks are assigned to agents ordered based on time of arrival, and agents receive tasks ordered based on the time when those agents became available. This strategy may be referred to as a “first-in, first-out,” “FIFO,” or “round-robin” strategy. For example, in an L2 environment, when an agent becomes available, the task at the head of the queue would be selected for assignment to the agent. In other traditional task assignment centers, a performance-based routing (PBR) strategy for prioritizing higher-performing agents for task assignment may be implemented. Under PBR, for example, the highest-performing agent among available agents receives the next available task.

The present disclosure refers to optimized strategies, such as “Behavioral Pairing” or “BP” strategies, for assigning tasks to agents that improve upon traditional assignment methods. BP targets balanced utilization of agents while simultaneously improving overall task assignment center performance potentially beyond what FIFO or PBR methods will achieve in practice. This is a remarkable achievement inasmuch as BP acts on the same tasks and same agents as FIFO or PBR methods, approximately balancing the utilization of agents as FIFO provides, while improving overall task assignment center performance beyond what either FIFO or PBR provide in practice. BP improves performance by assigning agent and task pairs in a fashion that takes into consideration the assignment of potential subsequent agent and task pairs such that, when the benefits of all assignments are aggregated, they may exceed those of FIFO and PBR strategies.

Various BP strategies may be used, such as a diagonal model BP strategy or a network flow BP strategy. These task assignment strategies and others are described in detail for a contact center context in, e.g., U.S. Pat. Nos. 9,300,802, 9,781,269, 9,787,841, and 9,930,180, all of which are hereby incorporated by reference herein. BP strategies may be applied in an L1 environment (agent surplus, one task; select among multiple available/idle agents), an L2 environment (task surplus, one available/idle agent; select among multiple tasks in queue), and an L3 environment (multiple agents and multiple tasks; select among pairing permutations).

In some task assignment systems, tasks may be allocated to a plurality of queues of agents without typically transmitting all of the information about the allocated tasks to each of the respective queues. However, if a queue operates under BP strategy, it may be advantageous for each of the queue to have more information about the tasks arriving at the task assignment system. Thus, it may be understood that there may be a need for transmitting more information about tasks arriving at a task assignment system to all queues of agents in order to optimize the overall performance task assignment system.

The description herein describes network elements, computers, and/or components of a system and method for pairing strategies in a task assignment system that may include one or more modules. As used herein, the term “module” may be understood to refer to computing software, firmware, hardware, and/or various combinations thereof. Modules, however, are not to be interpreted as software which is not implemented on hardware, firmware, or recorded on a non-transitory processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

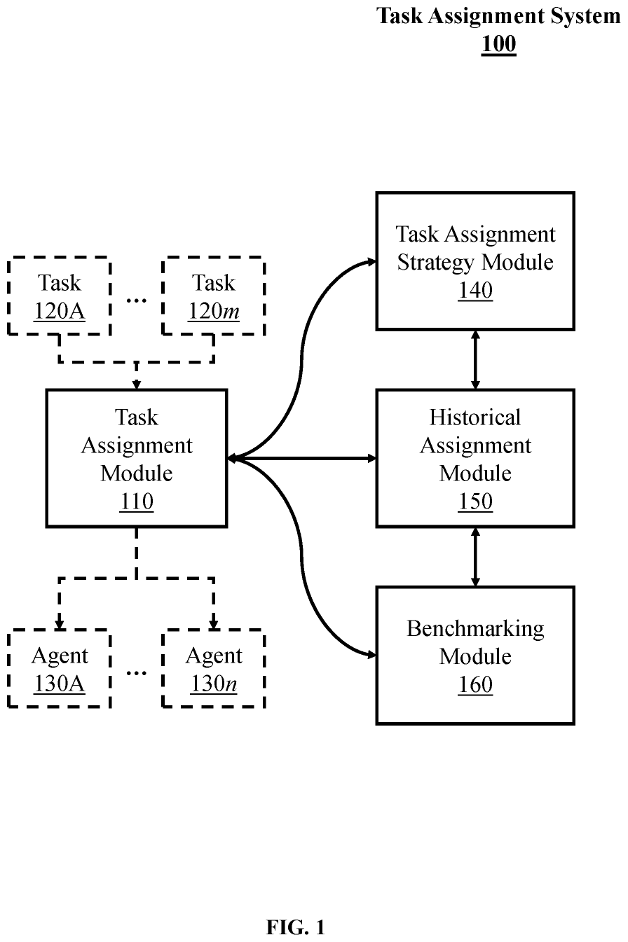

FIG. 1 shows a block diagram of a task assignment system 100 according to embodiments of the present disclosure. The task assignment system 100 may be included in a task assignment center (e.g., contact center) or incorporated in a component or module (e.g., a pairing module) of a task assignment center for helping to assign tasks (e.g., contacts) among various agents. The task assignment system 100 may include a task assignment module 110 that is configured to pair (e.g., match, assign) incoming tasks to available agents. In the example of FIG. 1, m tasks 120A-120m are received over a given period, and n agents 130A-130n are available during the given period. Each of the m tasks may be assigned to one of the n agents for servicing or other types of task processing. In the example of FIG. 1, m and n may be arbitrarily large finite integers greater than or equal to one. In a real-world task assignment center, such as a contact center, there may be dozens, hundreds, etc. of agents logged into the contact center to interact with contacts during a shift, and the contact center may receive dozens, hundreds, thousands, etc. of contacts (e.g., telephone calls, internet chat sessions, emails, etc.) during the shift.

In some embodiments, a task assignment strategy module 140 may be communicatively coupled to and/or configured to operate in the task assignment system 100. The task assignment strategy module 140 may implement one or more task assignment strategies (or “pairing strategies”) for assigning individual tasks to individual agents (e.g., pairing contacts with contact center agents). A variety of different task assignment strategies may be devised and implemented by the task assignment strategy module 140. In some embodiments, a FIFO strategy may be implemented in which, for example, the longest-waiting agent receives the next available task (in L1 environments) or the longest-waiting task is assigned to the next available agent (in L2 environments). In other embodiments, a PBR strategy for prioritizing higher-performing agents for task assignment may be implemented. Under PBR, for example, the highest-performing agent among available agents receives the next available task. In yet other embodiments, a BP strategy may be used for optimally assigning tasks to agents using information about either tasks or agents, or both. Various BP strategies may be used, such as a diagonal model BP strategy or a network flow BP strategy. See U.S. Pat. Nos. 9,300,802, 9,781,269, 9,787,841, and 9,930,180.

In some embodiments, a historical assignment module 150 may be communicatively coupled to and/or configured to operate in the task assignment system 100 via other modules such as the task assignment module 110 and/or the task assignment strategy module 140. The historical assignment module 150 may be responsible for various functions such as monitoring, storing, retrieving, and/or outputting information about task-agent assignments that have already been made. For example, the historical assignment module 150 may monitor the task assignment module 110 to collect information about task assignments in a given period. Each record of a historical task assignment may include information such as an agent identifier, a task or task type identifier, offer or offer set identifier, outcome information, or a pairing strategy identifier (i.e., an identifier indicating whether a task assignment was made using a BP strategy, or some other pairing strategy such as a FIFO or PBR pairing strategy).

In some embodiments and for some contexts, additional information may be stored. For example, in a call center context, the historical assignment module 150 may also store information about the time a call started, the time a call ended, the phone number dialed, and the caller's phone number. For another example, in a dispatch center (e.g., “truck roll”) context, the historical assignment module 150 may also store information about the time a driver (i.e., field agent) departs from the dispatch center, the route recommended, the route taken, the estimated travel time, the actual travel time, the amount of time spent at the customer site handling the customer's task, etc.

In some embodiments, the historical assignment module 150 may generate a pairing model or a similar computer processor-generated model based on a set of historical assignments for a period of time (e.g., the past week, the past month, the past year, etc.), which may be used by the task assignment strategy module 140 to make task assignment recommendations or instructions to the task assignment module 110.

In some embodiments, a benchmarking module 160 may be communicatively coupled to and/or configured to operate in the task assignment system 100 via other modules such as the task assignment module 110 and/or the historical assignment module 150. The benchmarking module 160 may benchmark the relative performance of two or more pairing strategies (e.g., FIFO, PBR, BP, etc.) using historical assignment information, which may be received from, for example, the historical assignment module 150. In some embodiments, the benchmarking module 160 may perform other functions, such as establishing a benchmarking schedule for cycling among various pairing strategies, tracking cohorts (e.g., base and measurement groups of historical assignments), etc. Benchmarking is described in detail for the contact center context in, e.g., U.S. Pat. No. 9,712,676, which is hereby incorporated by reference herein.

In some embodiments, the benchmarking module 160 may output or otherwise report or use the relative performance measurements. The relative performance measurements may be used to assess the quality of the task assignment strategy to determine, for example, whether a different task assignment strategy (or a different pairing model) should be used, or to measure the overall performance (or performance gain) that was achieved within the task assignment system 100 while it was optimized or otherwise configured to use one task assignment strategy instead of another.

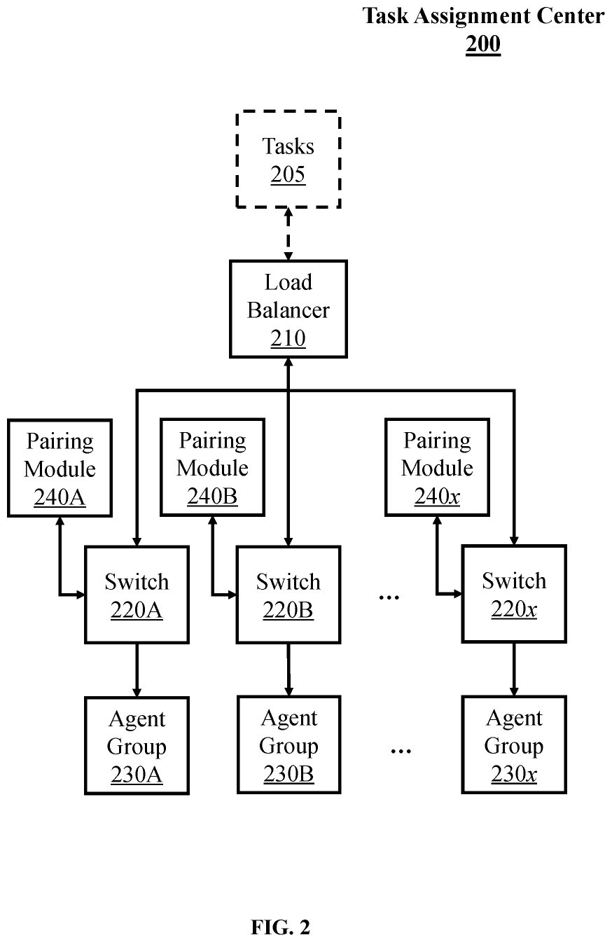

FIG. 2 shows a block diagram of a task assignment center 200 according to embodiments of the present disclosure. The task assignment center 200 may include a load balancer 210. In some embodiments, the task assignment center 200 may include multiple load balancers, which may be configured hierarchically (not shown). The load balancer 210 may receive incoming tasks 205. The task assignment center 200 may be a contact center, where the incoming tasks 205 correspond to contacts (e.g., telephone calls, internet chat sessions, emails, etc.). The load balancer 210 may include routing hardware and software for helping to route tasks among one or more subcenters, or to one or more Private Branch Exchange (“PBX”) or Automatic Call Distribution (ACD) routing components or other queuing or switching components within the task assignment center 200. In some embodiments, the load balancer 210 may support outbound connections to contacts via a dialer, a telecommunications network, or other modules (not shown). The load balancer 210 may not be necessary if there is only one subcenter, or if there is only one PBX or ACD routing component in the task assignment center 200.

If the task assignment center 200 includes more than one, e.g., x, subcenters, each subcenter may include at least one switch (e.g., switches 220A, 220B, . . . , 220x). The switches 220A-220x may be communicatively coupled to the load balancer 210. Each switch for each subcenter may be communicatively coupled to a group of agents (e.g., agent groups 230A, 230B, . . . , 230x), which includes a plurality (or “pool”) of agents. Each switch may support a certain number of agents (or “seats”) to be logged in at one time. At any given time, a logged-in agent may be available and waiting to be connected to a task, or the logged-in agent may be unavailable for any of a number of reasons, such as being connected to another contact, performing certain post-call functions such as logging information about the call, or taking a break. In the example of FIG. 2, the load balancer 210 routes tasks to one of the x subcenters via switches 220A-220x, respectively. Each of the switches 220A-220x may include ACD routing components or other queuing or switching components. In the example of FIG. 2, x may be an arbitrarily large finite integer greater than or equal to one.

In the example of FIG. 2, each of the switches 220A-220x may be communicatively coupled to a respective pairing module (e.g., pairing modules 240A, 240B, . . . , 240x). One of more of the pairing modules 240A-240x may be provided by, for example, a third-party vendor, and may be integrated in the task assignment center 200. In some embodiments, one or more of the pairing modules 240A-240x may be embedded within one or more components of the task assignment center 200 (e.g., one or more of the switches 220A-220x). Each of the pairing modules 240A-240x may comprise a task assignment system such as task assignment system 100.

Each pairing module (e.g., pairing module 240A) may receive information from its corresponding switch (e.g., switch 220A) about agents logged into the switch (e.g., the plurality of agent in agent group 230A) and about tasks allocated by the load balancer 210 or, in some embodiments, from a network (e.g., the Internet or a telecommunications network) (not shown). The pairing module may process this received information to determine which tasks should be paired (e.g., matched, assigned, distributed, routed) with which agents.

For example, in an L1 state, multiple agents may be available and waiting for connection to a task, and a new task gets to the switch allocated by the load balancer 210. As explained above, if the pairing module implements a FIFO strategy, the pairing module will instruct the switch to distribute the new task to whichever available agent has been waiting the longest amount of time for a task. If the pairing module implements a PBR strategy, whichever available agent has been determined to be the highest-performing agent will be assigned to the new task. With a BP strategy, tasks and agents may be given scores (e.g., percentiles or percentile ranges/bandwidths) according to a pairing model or other artificial intelligence data model, so that the new task may be matched, paired, or otherwise connected to a preferred agent.

In an L2 state, multiple tasks are allocated to the switch by the load balancer 210 and are waiting for connection to an agent. These tasks may be queued in the switch (i.e., the PBX or ACD device). When an agent becomes available, under a FIFO strategy or a PBR strategy when agent choice is not available, the pairing module will instruct the switch to connect the newly available agent to whichever task has been waiting on hold in the queue for the longest amount of time. However, if the pairing module implements a BP strategy, as in the L1 state described above, tasks and agents may be given percentiles (or percentile ranges/bandwidths, etc.) according to, for example, a model, such as an artificial intelligence model, so that an agent becoming available may be matched, paired, or otherwise connected to a preferred task.

In the example of FIG. 2, the load balancer 210 may receive, retrieve, or otherwise store (on one or more non-transitory processor readable storage media (e.g., a magnetic disk or other storage device)) information about the incoming tasks 205 (e.g., data such as a telephone number, a customer identifier, a geographical location of where a call originates, a caller's demographics, interactive voice response (IVR) or menu data, etc.). Some of this information may be transferred from the load balancer 210 to other modules in the task assignment system 200, such as switches 220A-220x or other agent systems (not shown) (e.g., computer-telephony integration (CTI) systems). However, some of this information or other information about the incoming tasks 205 may be passed along to the switches 220A-220x.

For example, the load balancer 210 may be configured to transfer IVR data to CTI system but not to any switch (e.g., switch 220A). Under typical FIFO or PBR strategies, the switch or ACD would not need IVR data to pair the task with an agent associated with the switch. However, under a BP strategy, the IVR data could be useful to a pairing module (e.g., pairing module 240A) to inform the selection of a task-agent pairing. Although this information about the incoming tasks 205 may be useful to a pairing module operating under a BP strategy for making optimized pairings, such information may not be available because it has not been transmitted from the load balancer 210 to the respective switch.

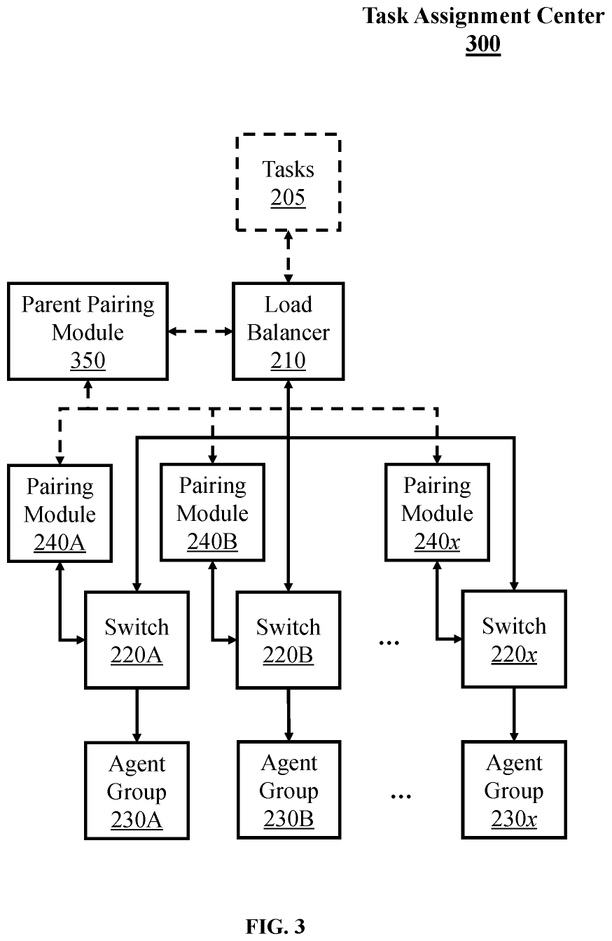

FIG. 3 shows a block diagram of a task assignment center 300 according to embodiments of the present disclosure. The task assignment center 300 is similar to task assignment center 200, except that it includes a parent pairing module 350. The parent pairing module 350 may be communicatively coupled to the load balancer 210. In other embodiments, the load balancer 210 may be configured to incorporate the features of the parent pairing module 350. The parent pairing module 350 may also be communicatively coupled to each of the pairing modules 240A-240x. The parent pairing module 350 may be configured to receive all information about the incoming tasks 205 from the load balancer 210 and broadcast this information to some or all of the pairing modules 240A-240x. In such a configuration, some or all of the pairing modules 240A-240x may receive and store a copy of the information about all of the incoming tasks 205 that the parent pairing module 350 receives from the load balancer 210. The parent pairing module 350 may associate information about each of the incoming tasks 205 with a task identifier (“task ID”) that uniquely identifies each task, so the pairing modules 240A-240x that receive and store a copy of the information can retrieve the information later using a task ID for the relevant task.

When the load balancer 210 allocates a task to a switch (e.g., switch 220A), the corresponding pairing module (e.g., pairing module 240A) may consider the additional data such as variables or other parameters sent by the parent pairing module 350 in formulating its BP strategy or updating its BP model. With information about all incoming tasks available, the BP strategy may be further optimized to increase the overall performance of the task assignment center 300, beyond what the BP strategy could achieve, for example, in task assignment center 200.

Additionally, the parent pairing module 350 may receive historical assignment information from one of the pairing modules (e.g., pairing module 240A) and share the historical assignment information with the other pairing modules (e.g., pairing modules 240B-240x). Such sharing of historical assignment information among the pairing modules may also help to optimize the BP strategy and/or BP module of each of the pairing modules, thereby increasing the overall performance of the task assignment center 300.

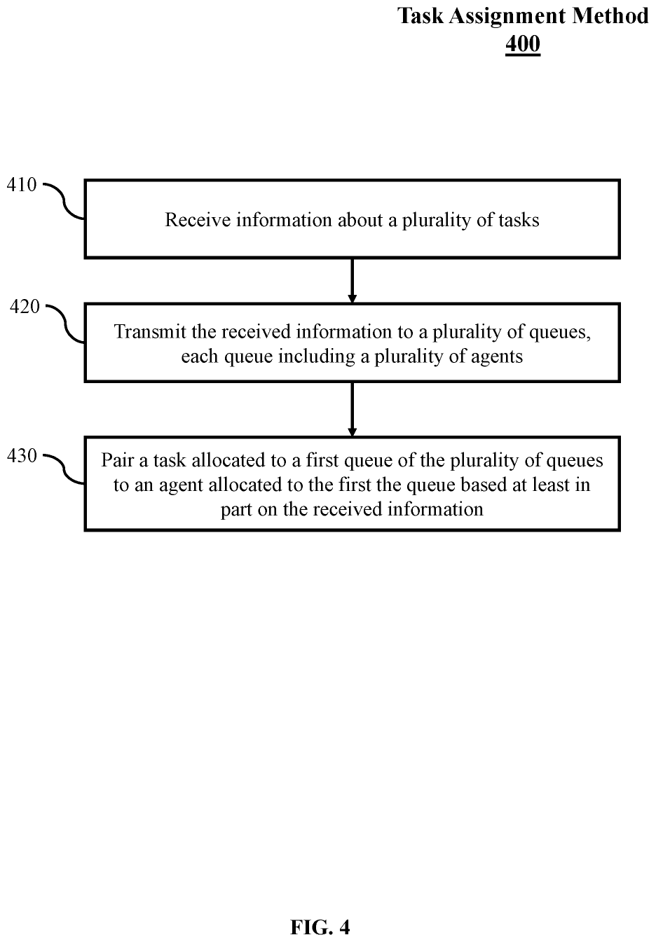

FIG. 4 shows a task assignment method 400 according to embodiments of the present disclosure.

Task assignment method 400 may begin at block 410. At block 410, the task assignment method 400 may receive information about a plurality of tasks (e.g., data such as a telephone number, a customer identifier, a geographical location of where a call originates, a caller's demographics, IVR or menu data, etc.) arriving at a task assignment center (e.g., task assignment center 300). For example, the information about the plurality of tasks (e.g., task 205) may be received by a parent pairing module (e.g., parent pairing module 350) from a load balancer (e.g., load balancer 210).

Task assignment method 400 may then proceed to block 420. At block 420, the task assignment method 400 may transmit the received information to a queue or a plurality of queues. Each of the plurality of queues may include a plurality of agents (e.g., agent groups 230A-230x). The received information may be transmitted to one or more pairing modules (e.g., pairing modules 240A-240x) that are communicatively coupled to respective switches (e.g., switches 220A-220x) of the plurality of queues. A task ID may be associated with the received information for each task.

The load balancer 210 may allocate a portion of the plurality of tasks to a queue of the plurality of queues. The portion may include one or more tasks. For example, a load balancer (e.g., load balancer 210) may allocate a portion of a plurality of tasks (e.g., tasks 205) to a switch (e.g., switch 220A) in a queue. In some embodiments, the allocation may be determined by the parent pairing module 350.

Task assignment method 400 may then proceed to block 430. At block 430, the task assignment method 400 may pair a task from the portion of the plurality of tasks to an agent in the queue based at least in part on the received information. For example, a pairing module (e.g., pairing module 240A) may pair a task allocated to its corresponding switch (e.g., switch 220A) to an agent logged into the switch based on information received from a parent pairing module (e.g., parent pairing module 350) about all the tasks (e.g., tasks 205) that have arrived at a task assignment center (e.g., task assignment center 300).

At this point it should be noted that task assignment in accordance with the present disclosure as described above may involve the processing of input data and the generation of output data to some extent. This input data processing and output data generation may be implemented in hardware or software. For example, specific electronic components may be employed in a behavioral pairing module or similar or related circuitry for implementing the functions associated with task assignment in accordance with the present disclosure as described above. Alternatively, one or more processors operating in accordance with instructions may implement the functions associated with task assignment in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A method for behavioral pairing in a task assignment system comprising:
receiving, by at least one computer processor communicatively coupled to and configured to operate in the task assignment system, information about a plurality of tasks;
transmitting, by the at least one computer processor, the received information to a plurality of queues, each queue including a plurality of agents; and
pairing, by the at least one computer processor, a task allocated to a first queue of the plurality of queues to an agent allocated to the first queue based at least in part on the received information.

2. The method of claim 1, wherein the task assignment system is a contact center system.

3. The method of claim 1, wherein the received information comprises at least one of a telephone number or a customer identifier associated with each of the plurality of tasks.

4. The method of claim 1, wherein the received information comprises at least one of an interactive voice response or a menu selection associated with each of the plurality of tasks.

5. The method of claim 1, further comprising, prior to the transmitting, storing, by the at least one computer processor and on a storage device, the received information.

6. The method of claim 1, further comprising:
receiving historical pairing information from each of the plurality of queues; and
transmitting the historical pairing information received from each of the plurality of queues to each other of the plurality of queues.

7. The method of claim 6, wherein the pairing is further based at least in part on the received historical pairing information.

8. A system for behavioral pairing in a task assignment system comprising:
at least one computer processor communicatively coupled to and configured to operate in the task assignment system, wherein the at least one computer processor is further configured to:
receive information about a plurality of tasks;
transmit the received information to a plurality of queues, each queue including a plurality of agents; and
pair a task allocated to a first queue of the plurality of queues to an agent allocated to the first queue based at least in part on the received information.

9. The system of claim 8, wherein the task assignment system is a contact center system.

10. The system of claim 8, wherein the received information comprises at least one of a telephone number or a customer identifier associated with each of the plurality of tasks.

11. The system of claim 8, wherein the received information comprises at least one of an interactive voice response or a menu selection associated with each of the plurality of tasks.

12. The system of claim 8, wherein the at least one computer processor is further configured to, prior to transmitting the received information, store the received information.

13. The system of claim 8, wherein the at least one computer processor is further configured to:
receive historical pairing information from each of the plurality of queues; and
transmit the historical pairing information received from each of the plurality of queues to each other of the plurality of queues.

14. The system of claim 13, wherein the at least one computer processor is configured to pair the task further based at least in part on the received historical pairing information.

15. An article of manufacture for behavioral pairing in a task assignment system comprising:
a non-transitory processor readable medium; and
instructions stored on the medium;
wherein the instructions are configured to be readable from the medium by at least one computer processor communicatively coupled to and configured to operate in the task assignment system and thereby cause the at least one computer processor to operate so as to:
receive information about a plurality of tasks;
transmit the received information to a plurality of queues, each queue including a plurality of agents; and
pair a task allocated to a first queue of the plurality of queues to an agent allocated to the first queue based at least in part on the received information.

16. The article of manufacture of claim 15, wherein the task assignment system is a contact center system.

17. The article of manufacture of claim 15, wherein the received information comprises at least one of a telephone number or a customer identifier associated with each of the plurality of tasks.

18. The article of manufacture of claim 15, wherein the received information comprises at least one of an interactive voice response or a menu selection associated with each of the plurality of tasks.

19. The article of manufacture of claim 15, wherein the instructions are configured to cause the at least one computer processor to operate so as to, prior to transmitting the received information, store the received information.

20. The article of manufacture of claim 15, wherein the instructions are configured to cause the at least one computer processor to operate so as to further:
receive historical pairing information from each of the plurality of queues; and
transmit the historical pairing information received from each of the plurality of queues to each other of the plurality of queues.

21. The article of manufacture of claim 20, wherein the instructions are configured to cause the at least one computer processor to operate so as to pair the task further based at least in part on the received historical pairing information.
